(19) United States
(12) Patent Application Publication
(10) Pub. No.: US 2013/0200582 A1
(43) Pub. Date: Aug. 8, 2013

(54) Wheelbarrow Or Cart With Handles Which Can Be Extended In Step Less Increments

(71) Applicant: William Kurt Feick, New Canaan, CT (US)

(72) Inventor: William Kurt Feick, New Canaan, CT (US)

(21) Appl. No.: 13/366,337

(22) Filed: Feb. 5, 2012

(51) Int. Cl. B62B 1/00

(52) U.S. Cl. 280/47.17

(57) ABSTRACT

A wheelbarrow or cart with a forwardly located wheel and two rearwardly located stand guards having first and second tubular support legs adapted to be attached to the stand guards, and first and second tubular leg members having outside diameters slidably coupled in telescoping arrangement with the inside diameters of the first and second tubular support legs. A first twist clamp means is coupled to frictionally engage and selectively lock the first tubular support leg relative to the first tubular leg member to set the total length of the first telescoping tubes and a second twist clamp means coupled to frictionally engage and selectively lock the second tubular support leg relative to the second tubular leg member to set the total length of the second telescoping tubes.

### BACKGROUND OF THE INVENTION

1. Field of the Invention

The present invention relates generally to handles for wheelbarrows or carts and, more particularly to a handle which can be telescoped to a desired length in step less increments.

2. Description of Related Art

Telescoping handles for wheelbarrows and carts is known in the prior art. More specifically, by way of example, U.S. PreGrant Publication No. 2004/0026899 to Shapiro discloses a cart having handles which may telescope or extend between two positions or may pivot about 180 degrees to fold along the underside of the cart.

U.S. Pat. No. 7,337,495 to Jung, et al. discloses a replaceable telescoping handle having a release and retaining mechanism in a base to which the telescoping handle is installed. A user can obtain a replacement telescoping handle, release and remove a broken telescoping handle using the release and retaining mechanism, and then install the replacement telescoping handle.

U.S. Pat. No. 6,336,254 to Graff, et al. discloses a handle which is attached to a straight wheelbarrow handle. The handle has a specially designed flared end which engages the wheelbarrow handle and is curved downward and away from the wheelbarrow handle to form semi-circular shape.

U.S. Pat. No. 5,915,706 to Mosley discloses a wheelbarrow having tubular handles which are slideably and rotatively adjustable.

U.S. Pat. No. 5,810,375 to Hoffarth, et al. discloses a wheelbarrow handle having a closed loop hand-grip which can be an integral portion of the handle, or retrofitted to existing wheelbarrow handles.

U.S. Pat. No. 5,149,116 to Donze, et al. discloses telescoping handles where each handle has a tubular member slideably mounted on a fixed arm which has holes for receiving cotter pins. The telescopic adjustment of the length of the tubular members permits the height of the hand grips to be adjusted to avoid an uncomfortable working position.

U.S. Pat. No. 4,683,610 to Richards, et al. discloses an extension for a handle having a hollow cylindrical shaped tube formed with a series of circumferentially spaced slots that provide intervening strips of tube material adjacent to but spaced from an open end of the tube. A manually operated clamping band encircles the strips of tube material and clamps the strip against a handle inserted into the tube bore.

U.S. Pat. No. 4,471,996 to Primeau discloses an elongated handle pivotally movable between a first position where the handle extends rearwardly of a frame, and a second position whereat the frame support means is retracted from its supporting position. A releasable locking means is provided for interlocking the handle means with the frame.

U.S. Pat. No. 2,571,595 to McLeary discloses a wheelbarrow with handles having extensions which are in telescoping engagement with the handles and are releasably held in adjusted positions by latches and may be entirely removed from the handles.

U.S. Pat. No. 1,202,601 to Snyder discloses tubular members which are open at their rear ends to slidably receive tubular telescopic members. By moving the members inwardly and outwardly, the effective lengths of the handles may be varied as a variation in a load requires.

U.S. Pat. No. 559,001 to Stone discloses telescoping handles which have defined stop positions for adjusting the handles to the height of the user.

### SUMMARY OF THE INVENTION

In an exemplary embodiment of the present invention, there is disclosed a wheelbarrow or cart with a forwardly located wheel and two rearwardly located stand guards having a first tubular support leg adapted to be attached to one of the stand guards, a first tubular leg member having an outside diameter slidably coupled in telescoping arrangement with the inside diameter of the first tubular support leg, a second tubular support leg adapted to be attached to other of the stand guards and a second tubular leg member having an outside diameter slidably coupled in telescoping arrangement with the inside diameter of the second tubular support leg. A first twist clamp means is coupled to frictionally engage and selectively lock the first tubular support leg relative to the first tubular leg member to set the total length of the first telescoping tubes and a second twist clamp means coupled to frictionally engage and selectively lock the second tubular support leg relative to the second tubular leg member to set the total length of the second telescoping tubes.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a view of a step less telescoping U shaped handle for use on a cart for children of various ages or handicapped people in wheelchairs in accordance with the principles of the invention;

FIG. 2 is a partial sectional view of the telescoping U shaped handle of

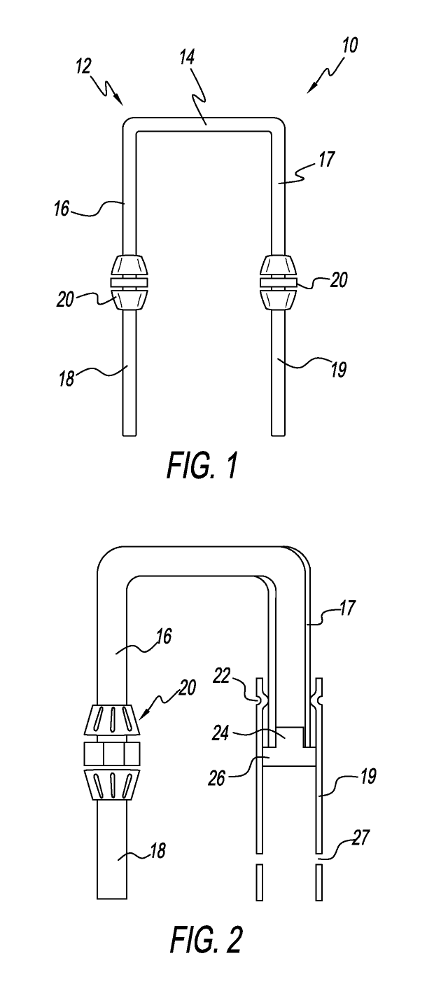

FIG. 1 that can be extended to a desired length in step less increments;

FIG. 3 is an exploded view of a twist lock for clamping the telescoping sections of the handle together;

FIG. 4 is a view of another embodiment of the handle of FIG. 1 in accordance with the principles of the invention;

FIG. 5 is a perspective view of a cart showing the U shaped step less handle in a retracted and extended position in accordance with the principles of the invention;

FIG. 6 is a perspective view showing the end of one leg of the U shaped handle located in a sleeve attached to the stand guard of a cart and attached to the stand guard with a single threaded bolt in accordance with the principles of the invention; and

FIG. 7 is a view of the handle of the embodiment of FIG. 4 attached to a cart in accordance with the principles of the invention.

### DESCRIPTION OF THE PREFERRED EMBODIMENT

Referring to FIG. 1, there is disclosed a view of a telescoping U shaped handle 10 that is expandable in step less increments for use on a cart for children of various ages or handicapped people in wheelchairs in accordance with the principles of the invention. The U shaped handle consists of a tubular steel member 12 shaped to have a hand grip member 14 connected to two leg members 16, 17 with generous radius bends. Each leg member is slidably received by a support leg where leg member 16 is slidably coupled to support leg 18 and leg member 17 is slidably coupled to support leg 19. In one embodiment the leg members 16, 17 may be made of tubular steel with an outside diameter of about three-quarters of an inch and a length of about twenty two inches. Support legs 18, 19 may be made of tubular steel having an inside diameter that is slightly more than three-quarters of an inch to form a sliding fit with the outside diameter of leg members 16, 17. Twist clamp members 20 frictionally engage the outside surfaces of the leg members 16, 17 and support legs 18, 19 and, when tightened, lock the leg members to the support legs.

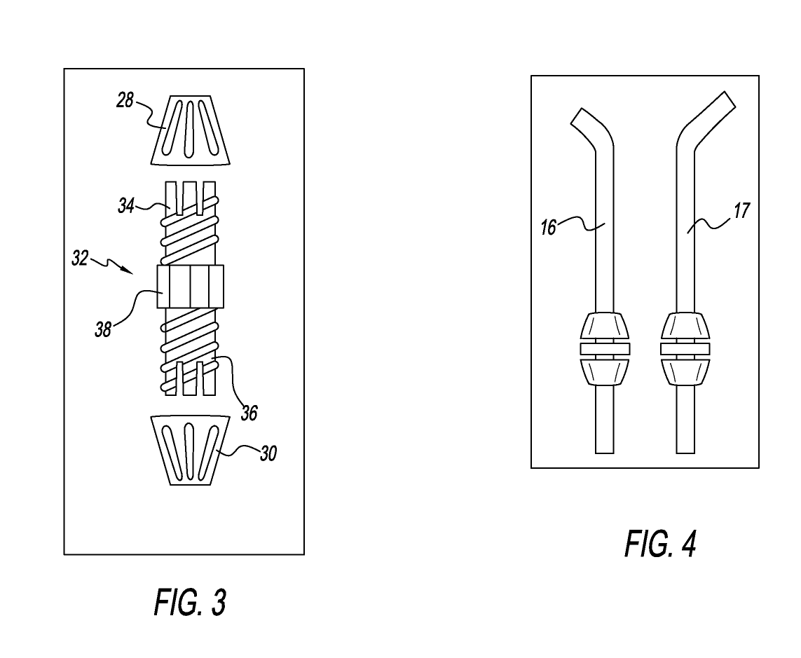

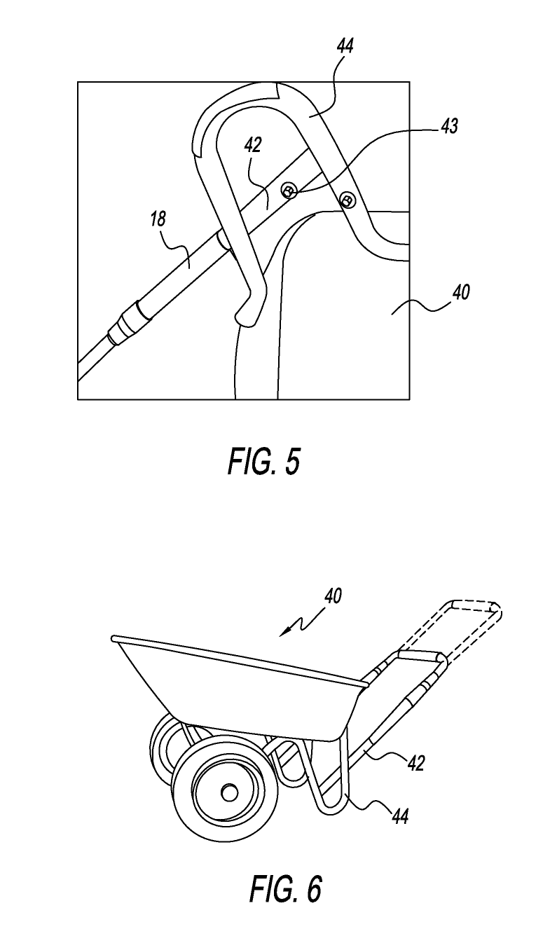

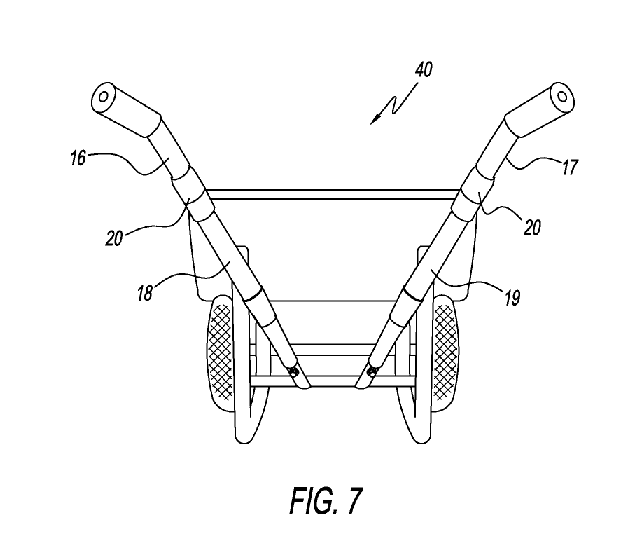

Referring to FIG. 2, there is disclosed the telescoping U shaped handle of FIG. 1 where a sectional view is shown of one-half of the U shaped handle absent the twist clamp member, and a plan view is shown of the other half of the U shaped handle including the twist clamp member in accordance with the principles of the invention.

Referring to the sectional half of the U shaped handle, leg member 17 has an overall length of about twenty two inches, an outside diameter of about three-quarters of an inch, and is slidably coupled to support leg 19 which has an overall length of about fifteen and one-half inches and an outside diameter of about one inch. Support leg 19 has an inwardly protruding ring 22 with an inside diameter that is slightly greater than the outside diameter of leg member 17 to provide a close tolerance sliding fit with leg member 17. The inwardly projecting ring is located about one and one-quarter inches in from the end of the tube. A hard rubber or plastic stop member 24 having a shoulder 26 is force fit into the end of the leg member 17. The shoulder 26 has a diameter that is less than the inside diameter of support leg 19 but greater than the inside diameter of the inwardly projecting ring 22. Thus, support leg 19 can freely slide along the length of leg member 17 but the shoulder 26, which has an outside diameter that is larger than the inside diameter of the inwardly protruding ring, prevents support leg from sliding off the end of leg member 17. A three-eighths of an inch clearance opening 27 located about seven-eighths of an inch back from the end of support leg is provided for receiving a bolt for connecting the handle to a mounting sleeve on a wheelbarrow or cart. Looking now at leg member 16 and support leg 18, a twist clamp member 20 is positioned to slide along and selectively frictionally engage the leg member 16 while frictionally engaging the upper end of the support leg 18 to control the length that the support leg extends from the leg member.

Referring to FIG. 3, there is shown an exploded view of the twist lock 20 for clamping the telescoping sections, the leg member to the support member, of the handle together. The twist lock has three members, a top screw cap 28, a bottom screw cap 30, and a center friction locking member 32 having an upper slotted tube 34, a lower slotted tube 36 and a hex shaped body 38. The top screw cap has a counter clockwise thread and the bottom screw cap has a clockwise thread. Thus, in operation the two screw caps can be tightened simultaneously by grasping the top and bottom screw caps in each hand and twisting one hand in a clockwise direction while at the same time twisting the other hand in a counter clockwise direction. The upper slotted tube 34 has a length of about one and three-quarters of an inch, and an inside diameter of three-quarters of an inch for receiving leg member 16 which has an outside diameter of three-quarters of an inch. The lower slotted tube 36 has a length of about one and three-eighths of an inch and an inside diameter of one inch for receiving leg member 18 which has an outside diameter of one inch. As the top and bottom caps are threaded onto the center friction engaging member 32, they squeeze the slotted ends of the upper and lower slotted tubes against the leg member and the support leg tubes which frictionally engage and lock the center friction engaging member 32 to the leg member 16 and the support leg 18. Thus, the twist clamp member controls the total length of the leg of the U shaped member which can be selectively set to any length in step less increments.

Referring to FIG. 4 there is shown a view of another embodiment of the handle of FIG. 1 in accordance with the principles of the invention. In this embodiment the leg members 16, 17 are not connected together, they are independent of each other and hand grips are provided by bending the upper ends of each leg member to a convenient angle.

Referring to FIG. 5, there is shown a perspective view of a cart 40 with the U shaped step less handle 10 in a retracted position and an extended position in accordance with the principles of the invention. The handle is attached to a mounting sleeve 42 with a single bolt 43 that passes through the mounting sleeve 42 and the clearance opening 27 located in each support leg 16, 18. The mounting sleeve is welded to the stand guard 44

Referring to FIG. 6, there is shown a perspective view of the end of one support leg of the U shaped handle located in the mounting sleeve which is welded to the stand guard of a cart where the support leg is attached to the mounting sleeve with a single threaded bolt in accordance with the principles of the invention.

Referring to FIG. 7, there is shown a view of the independent handles of the embodiment of FIG. 4 attached to the cart 40 in accordance with the principles of the invention. In this embodiment the mounting sleeves are oriented to locate the leg members and support legs to have an open V shape.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A wheelbarrow or cart having at least one forwardly located wheel and two rearwardly located stand guards comprising:
a first tubular support leg adapted to be attached to one of the stand guards;
a first tubular leg member having an outside diameter slidably coupled in telescoping arrangement with the inside diameter of the first tubular support leg;
a second tubular support leg adapted to be attached to other of the stand guards;
a second tubular leg member having an outside diameter slidably coupled in telescoping arrangement with the inside diameter of the second tubular support leg;
a first twist clamp means coupled to frictionally engage and selectively lock the first tubular support leg relative to the first tubular leg member to set the total length of the first telescoping tubes; and
a second twist clamp means coupled to frictionally engage and selectively lock the second tubular support leg relative to the second tubular leg member to set the total length of the second telescoping tubes.

2. The wheelbarrow or cart of claim 1 wherein the first and second twist clamps can selectively frictionally engage the leg members or the support legs separately or simultaneously.

3. The wheelbarrow or cart of claim 2 wherein an inwardly protruding ring located proximate an end of each support leg has a diameter that is less than the inside diameter of the support leg to form a sliding fit with the outside diameter of each leg member.

4. The wheelbarrow or cart of claim 3 wherein a stop member is attached to the end of each leg member to prevent the leg members from being separated from the support legs.

5. The wheelbarrow or cart of claim 4 wherein the stop member has a shoulder that extends over the edge of the leg member which prevents the leg member from being separated from the support leg.

6. The wheelbarrow or cart of claim 5 wherein the diameter of the shoulder of the stop member is less than the inside diameter of the support leg and greater than the diameter if the inwardly protruding ring.

7. The wheelbarrow or cart of claim 6 wherein the stop member is made of rubber or plastic.

8. The wheelbarrow or cart of claim 5 wherein each twist clamp has a top screw cap, a bottom screw cap and a center friction engaging member having an upper slotted tube for frictionally engaging the leg member when the top screw cap is tightened, and a lower slotted tube for frictionally engaging the support leg when the bottom screw cap is tightened.

8. The wheelbarrow or cart of claim 8 wherein the top screw cap is tightened when rotated in a direction that is opposite to the direction of rotation of the bottom screw cap.

9. The wheelbarrow of claim 8 wherein the ends of the leg members are connected to each other with a hand grip member.

10. The wheelbarrow of claim 9 wherein the leg members and hand grip member are formed from a single tube.

11. The wheelbarrow of claim 10 wherein the leg members and hand grip member are made of tubular steel.

12. The wheelbarrow of claim 11 wherein the support legs each have a bolt clearance opening for attaching the support legs to a wheelbarrow or cart with a single bolt.
